(19) United States
(12) Patent Application Publication
(10) Pub. No.: US 2014/0048997 A1
(43) Pub. Date: Feb. 20, 2014

(54) DEVICE FOR ASSEMBLING CAMERA MODULE WITH HIGH QUALITY

(71) Applicants: YU-TSAN CHENG, Tu-Cheng (TW); WEN-HSIUNG CHEN, Tu-Cheng (TW); SHIN-WEN CHEN, Tu-Cheng (TW); WEN-CHANG CHEN, Tu-Cheng (TW); ZHE WANG, Shenzhen City (CN); FU-LI LONG, Shenzhen City (CN)

(72) Inventors: YU-TSAN CHENG, Tu-Cheng (TW); WEN-HSIUNG CHEN, Tu-Cheng (TW); SHIN-WEN CHEN, Tu-Cheng (TW); WEN-CHANG CHEN, Tu-Cheng (TW); ZHE WANG, Shenzhen City (CN); FU-LI LONG, Shenzhen City (CN)

(21) Appl. No.: 13/654,635

(22) Filed: Oct. 18, 2012

(30) Foreign Application Priority Data
Aug. 15, 2012 (CN) 2012102897084

(51) Int. Cl. B23Q 3/00

(52) U.S. Cl. 269/303

(57) ABSTRACT

A device for assembling a camera module includes a base and a buffer layer. The camera module includes a flexible printed circuit board (FPCB), a lens module positioned on the FPCB, and a stiffener adhering to the FPCB, opposite to the lens module. The lens module includes a first stepped surface facing away from the FPCB. The base includes a supporting surface for supporting the FPCB and defines a holding groove in the supporting surface for holding the lens module. The holding groove forms a second stepped surface for supporting the first stepped surface. The buffer layer is positioned on the second stepped surface and is elastically compressed when the camera module is subjected to a hot pressing process, which secures the stiffener adhering to the FPCB, to provide relief against, and extend the duration of, various pressures applied to the camera module.

### BACKGROUND

1. Technical Field

The present disclosure relates to camera module assembling technologies and, particularly to a device for high quality assembly of a camera module.

2. Description of Related Art

Camera modules include a flexible printed circuit board (FPCB) and a lens module positioned on the FPCB. To increase mechanical strength, the camera module also includes a stiffener adhered to the FPCB, opposite to the lens module. The stiffener is typically made of conductive metal and is electrically grounded via the FPCB, thus providing shielding against electro-magnetic interference (EMI). The stiffener is adhered to the FPCB via adhesive and requires a hot pressing process to be firmly secured to the FPCB. However, the lens module may be damaged if the pressing is too heavy and quick and the stiffener cannot be firmly secured if the pressing is too light and slow, degrading the quality of the camera module.

Therefore, it is desirable to provide a device for assembling a camera module, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a cross-sectional schematic view of a device for assembling a camera module, according to an embodiment.

FIG. 2 is an isometric schematic view of the camera module of FIG. 1.

FIG. 3 is an isometric, exploded, schematic view of the camera module of FIG. 2.

FIG. 4 is similar to FIG. 3, but viewed from another angle.

### DETAILED DESCRIPTION

Embodiments of the present disclosure will be described with reference to the drawings.

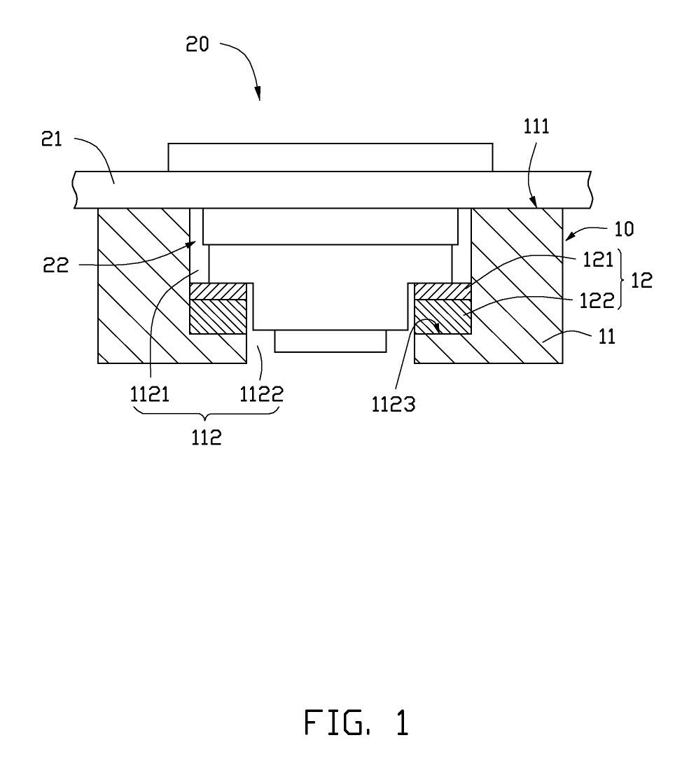

Referring to FIG. 1, a device 10 for assembling a camera module 20 according to an embodiment is shown.

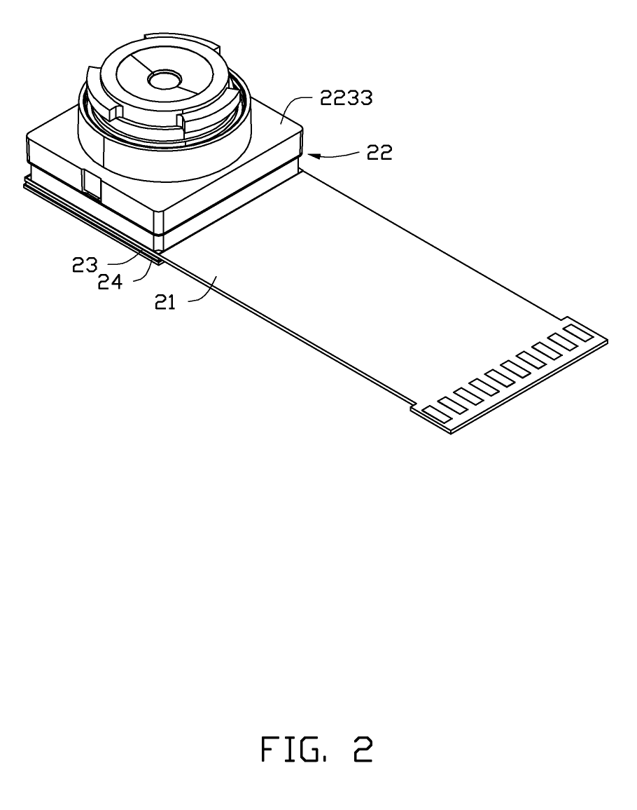

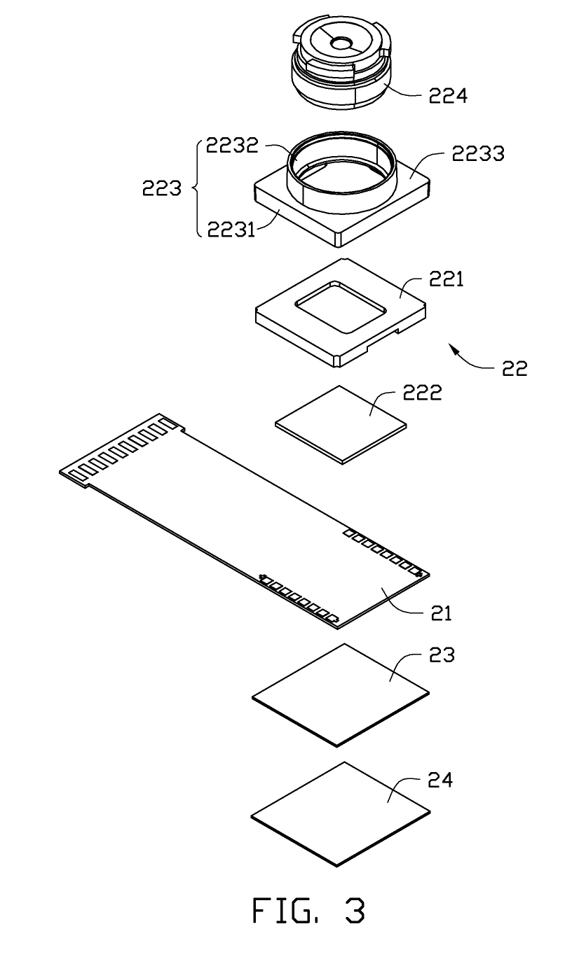

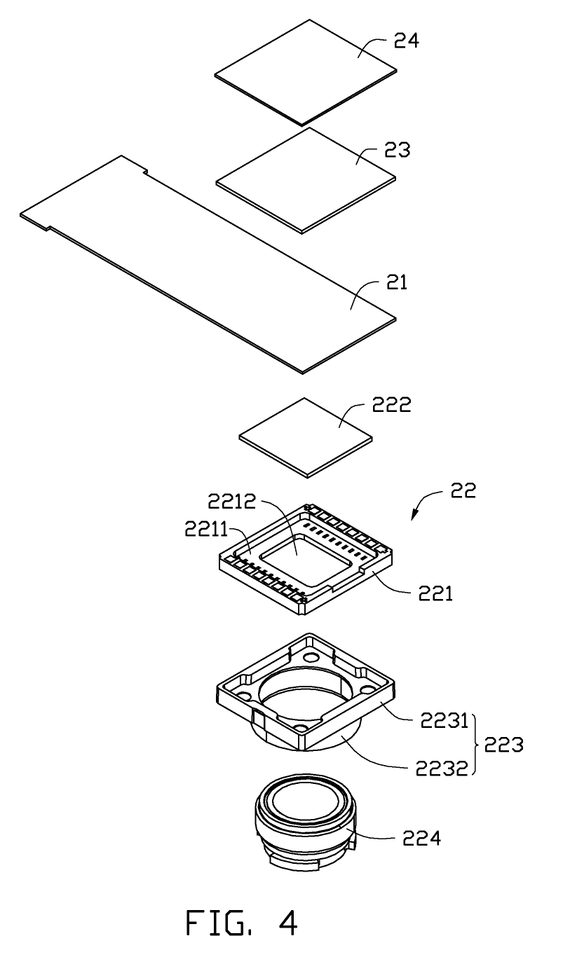

Referring to FIGS. 2-4, the camera module 20 includes a flexible printed circuit board (FPCB) 21, a lens module 22, a conductive adhesive layer 23, and a stiffener 24. The lens module 22 is positioned on the FPCB 21. The stiffener 24 is adhesively attached to the FPCB 21, opposite to the lens module 22, via the conductive adhesive layer 23.

The lens module 22 includes a ceramic substrate 221, an image sensor 222, a lens holder 223, and a lens 224. The image sensor 222 is positioned on the ceramic substrate 221 via a flip chip package method. The lens holder 223 is positioned on the ceramic substrate 221, opposite to the image sensor 222. The lens 224 is held in the lens holder 223.

The ceramic substrate 221 is positioned on and electrically connected to the FPCB 21. The ceramic substrate 221 is substantially rectangular and defines a rectangular receiving groove 2211 generally at the center thereof. The ceramic substrate 221 also defines a rectangular through hole 2212 contained within the receiving groove 2211.

The image sensor 222 is attached to a bottom surface of the receiving groove 2211 via the flip chip package method. The image sensor 222 is positioned between the ceramic substrate 221 and the FPCB 21.

An interior of the lens holder 223 communicates with the receiving groove 2211 via the through hole 2212. The lens holder 223 includes a rectangular shell 2231 positioned on the ceramic substrate 221, opposite to the image sensor 222. The lens holder 223 also includes a circular tube 2232 extending generally from the center of the rectangular shell 2231. The size of the circular tube 2232 is smaller than the size of the rectangular shell 2231, thus forming a first stepped surface 2233 therebetween, facing away from the rectangular shell 2231.

The lens 224 is held in the circular tube 2232.

The device 10 holds the camera module 20 when the camera module 20 is subjected to a hot pressing process.

The device 10 includes a base 11 and a buffer layer 12.

The base 11 includes a supporting surface 111 for supporting the FPCB 21. The base 11 defines a holding groove 112 in the supporting surface 111 for holding the lens module 22. The holding groove 112 has a rectangular section 1121 and a circular section 1122. The rectangular section 1121 is adjacent to the supporting surface 111 and configured for receiving the ceramic substrate 221 and the rectangular shell 2231. The circular section 1122 extends from the rectangular section 1121 away from the supporting surface 111 and is configured for receiving the circular tube 2232. The size of the rectangular section 1121 is larger than the size of the circular section 1122, thereby forming a second stepped surface 1123, corresponding to the first stepped surface 2233 and facing away from the circular section 1122.

The buffer layer 12 is positioned on the second stepped surface 1123 and provides a resilient buffer against the pressure applied to the camera module 20 during the hot pressing process. The buffer layer 12 includes a hard rubber layer 122 positioned on the second stepped surface 1123 and a polyether ether ketone (PEEK) layer 121 positioned on and covering the hard rubber layer 122.

The hard rubber layer 122 is compressed when the camera module 20 is subjected to the hot pressing process, providing a certain degree of buffering against the force applied to the camera module 20. As such, a heavy and rapid pressing can be applied to the camera module 20 to ensure a firm and stable connection between the FPCB 21 and the stiffener 24. The presence of the buffer permits even a longer-term pressure without damage to the lens module 22.

The distance from the buffer layer 12 to the supporting surface 111 is smaller than the height of the lens module 22 when the buffer layer 12 (i.e., the hard rubber layer 122) is in the uncompressed state, while the distance from the buffer layer 12 to the supporting surface 111 is larger than the height o f the lens module 22 when the buffer layer 12 (i.e., the hard rubber layer 121) is at maximum compression. Thus, the buffer layer 12 can buffer virtually any degree of pressure on the camera module 20.

The PEEK layer 121 extends the service life of the hard rubber layer 121 as PEEK is a semi-crystalline thermoplastic with excellent mechanical and chemical resistance properties which are retained at high temperatures. In other embodiments, the PEEK layer 121 can be omitted if the hard rubber layer 122 has good mechanical and chemical properties.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A device for assembling a camera module, the camera module comprising a flexible printed circuit board (FPCB), a lens module positioned on the FPCB, and a stiffener adhered to the FPCB, opposite to the lens module, the lens module comprising a first stepped surface facing away from the FPCB, the device being configured to hold the camera module when the camera module subjects to a hot pressing process to cause the stiffener being firmly secured to the FPCB, the device comprising:
a base comprising a supporting surface for supporting the FPCB, the base defining a holding groove for holding the lens module, the holding groove forming a second stepped surface for supporting the first stepped surface; and
a buffer layer positioned on the second stepped surface, the buffer layer being capable of being elastically compressed when the camera module subjects to the hot pressing process to provide a long-term deformation to buffer an impulsive force applied to the camera module during the hot pressing process.

2. The device of claim 1, wherein a distance from the buffer layer to the supporting surface is smaller than a height of the lens module when the buffer layer is in a natural state, while the distance from the buffer layer to the supporting surface is larger than the height of the lens module when the buffer layer is in a maximum compression state.

3. The device of claim 1, wherein the buffer layer comprises a hard rubber layer positioned on the second stepped surface.

4. The device of claim 3, wherein the buffer layer comprises a polyether ether ketone layer positioned on and covering the hard rubber layer.
